(19) United States
(12) Patent Application Publication
(10) Pub. No.: US 2011/0061806 A1
(43) Pub. Date: Mar. 17, 2011

(54) MANUFACTURING METHOD OF IMAGE DISPLAY APPARATUS, AND BONDING METHOD OF BASE MATERIALS

(75) Inventors: Mitsutoshi Hasegawa, Yokohama-shi (JP); Mamo Matsumoto, Hiratsuka-shi (JP); Tomohiro Saito, Kouza-gun (JP)

(73) Assignee: CANON KABUSHIKI KAISHA, Tokyo (JP)

(21) Appl. No.: 12/875,980

(22) Filed: Sep. 3, 2010

(30) Foreign Application Priority Data
Sep. 14, 2009 (JP) 2009-211715

(51) Int. Cl. B29C 65/14

(52) U.S. Cl. 156/273.7

(57) ABSTRACT

A method comprises: arranging a bonding material between a pair of base materials; and bonding, as mutually pressing the pair of the base materials, the pair of the base materials by the bonding material, by irradiating an electromagnetic wave while moving an irradiation position along the bonding material to melt and then harden the bonding material, wherein the arranging includes arranging the bonding material on one of faces of the pair of the base materials so as to have a convex portion which continuously extends in a direction along which the bonding material extends and in which its central region in a width direction protrudes toward the other of the faces of the pair of the base materials. Thus, a stress according to heating and cooling of the base material is reduced and crack does not occur easily in a bonding portion.

### BACKGROUND OF THE INVENTION

1. Field of the Invention

The present invention relates to a manufacturing method of an image display apparatus and a bonding method of base materials, and more particularly to a bonding method of members constituting an envelope of the image display apparatus.

2. Description of the Related Art

There is known a method of, in a manufacturing process of an image display apparatus, interposing a bonding material between a pair of base materials, melting the bonding material by irradiating an electromagnetic wave such as a laser beam or the like to the bonding material, and thus bonding the pair of the base materials together. Here, Japanese Patent Application Laid-Open (Translation of PCT Application) 2008-517446 discloses a method of airtightly sealing up a cover plate and a substrate, by taking an organic light emitting diode display for example. In this method, a bonding material (frit) is previously applied in an appropriate way to the cover plate like a frame, and the cover plate is baked to burn out an organic binder included in the bonding material. After then, a laser beam is irradiated to the bonding material as lightly pressing the cover plate on which the bonding material has been formed and the substrate to each other, and the bonding material is thus melted, whereby the cover plate and the substrate are airtightly sealed up.

Incidentally, there are cases where the width-direction section of the baked bonding material has a shape that the vicinity of the center of the bonding material is concave. When the base material on which the bonding material having the above shape has been formed and the base material on which a bonding material is not formed are pressed to each other, a protruding portion of the bonding material positioned at the outside in the width direction of the bonding material comes into contact with the base material on which the bonding material is not formed. Then, when the bonding material is heated by irradiating the laser beam in such a state, a temperature of the base material on which the bonding material is not formed becomes high at the position where the base material is in contact with the bonding material. On the other hand, a temperature of the base material on which the bonding material is not formed is relatively low at the position where the base material is opposite to the concave portion of the bonding material at its center in the width direction because the base material is not in contact with the bonding material at this position. As a result, in a temperature distribution of the base material on which the bonding material is not formed, the low temperature portion is interposed between the high temperature portions in the width direction. When cooling progresses in such a state, particularly the high temperature portion which is in contact with the bonding material is rapidly cooled down and thus thermal contraction occurs. Thus, a large tensile stress is applied to the low temperature portion positioned between the high temperature portions, whereby there is a possibility that crack occurs.

### SUMMARY OF THE INVENTION

The present invention aims to provide a manufacturing method of an image display apparatus and a bonding method of base materials, in which a stress according to heating and cooling of the base material is reduced and crack does not occur easily in a bonding portion.

The present invention is characterized by a manufacturing method of an image display apparatus which comprises a first substrate having numerous electron-emitting devices, a second substrate positioned opposite to the first substrate and having a fluorescent film of displaying an image in response to irradiation of electrons emitted from the electron-emitting devices, and a frame member positioned between the first substrate and the second substrate to form a space between the first substrate and the second substrate, the method comprising: arranging a bonding material between a pair of base materials acting as the first substrate and the frame member or acting as the second substrate and the frame member, the bonding material extending along one of the base materials acting as the frame member; and bonding, as mutually pressing to each other the base materials of the pair of the base materials, the pair of the base materials by the bonding material, by irradiating an electromagnetic wave to the bonding material while moving an irradiation position along the bonding material to melt the bonding material, and then hardening the melted bonding material, wherein the arranging of the bonding material includes arranging the bonding material on one of faces of the pair of the base materials mutually opposite to each other so as to have a convex portion which continuously extends in a direction along which the bonding material extends and in which its central region in a width direction protrudes toward the other of the faces of the pair of the base materials.

Further, the present invention is characterized by a bonding method of base materials, comprising: arranging a bonding material between a pair of the base materials including a flat plate and a frame member, the bonding material extending along the frame member; and bonding, as mutually pressing to each other the base materials of the pair of the base materials, the pair of the base materials by the bonding material, by irradiating an electromagnetic wave to the bonding material while moving an irradiation position along the bonding material to melt the bonding material, and then hardening the melted bonding material, wherein the arranging of the bonding material includes arranging the bonding material on one of faces of the pair of the base materials mutually opposite to each other so as to have a convex portion which continuously extends in a direction along which the bonding material extends and in which its central region in a width direction protrudes toward the other of the faces of the pair of the base materials.

Further features of the present invention will become apparent from the following description of exemplary embodiments with reference to the attached drawings.

### BRIEF DESCRIPTION OF THE DRAWINGS

FIG. 1 is a perspective view illustrating an image display apparatus according to the present invention.

FIG. 2 is a cross section diagram of a bonding portion, for describing a process flow according to the present invention.

FIGS. 3A, 3B, 3C and 3D are two-dimensional diagrams each illustrating the bonding portion according to the present invention.

FIGS. 4A and 4B are partial cross section diagrams of the bonding portion according to the present invention.

FIGS. 5A, 5B, 5C, 5D, 5E and 5F are partial enlarged cross section diagrams of the bonding portion according to the present invention.

FIGS. 6A and 6B are schematic diagrams for describing an effect of the present invention.

### DESCRIPTION OF THE EMBODIMENTS

An aspect of the present invention is directed to a manufacturing method of an image display apparatus which comprises a first substrate having numerous electron-emitting devices, a second substrate positioned opposite to the first substrate and having a fluorescent film of displaying an image in response to irradiation of electrons emitted from the electron-emitting devices, and a frame member positioned between the first substrate and the second substrate to form a space between the first substrate and the second substrate. Here, the present invention comprises a step of arranging a bonding material between a pair of base materials acting as the first substrate and the frame member or acting as the second substrate and the frame member, the bonding material extending along one of the base materials acting as the frame member; and a step of bonding, as mutually pressing to each other the base materials of the pair of the base materials, the pair of the base materials by the bonding material, by irradiating an electromagnetic wave to the bonding material while moving an irradiation position along the bonding material to melt the bonding material, and then hardening the melted bonding material. Further, the step of arranging the bonding material includes to arrange the bonding material on one of faces of the pair of the base materials mutually opposite to each other so as to have a convex portion which continuously extends in a direction along which the bonding material extends and in which its central region in a width direction protrudes toward the other of the faces of the pair of the base materials.

The bonding material is arranged so as to have the convex portion in which the central region in the width direction protrudes toward the other of the faces of the pair of the base materials mutually opposite to each other. Consequently, in a temperature distribution on the other of the faces of the pair of the base materials opposite to each other at the time when the bonding material is melted, the temperature at the position which is in contact with the bonding material is high, and the temperature gradually reduces from the relevant position toward the outside of the bonding material in the width direction. Since an excessive stress is not generated even if cooling progresses in such a state, crack does not occur easily in the bonded base material.

Another aspect of the present invention is directed to a bonding method of base materials, which comprises: a step of arranging a bonding material between a pair of the base materials including a flat plate and a frame member, the bonding material extending along the frame member; and a step of bonding, as mutually pressing to each other the base materials of the pair of the base materials, the pair of the base materials by the bonding material, by irradiating an electromagnetic wave to the bonding material while moving an irradiation position along the bonding material to melt the bonding material, and then hardening the melted bonding material. The step of arranging the bonding material includes to arrange the bonding material on one of faces of the pair of the base materials mutually opposite to each other so as to have a convex portion which continuously extends in a direction along which the bonding material extends and in which its central region in a width direction protrudes toward the other of the faces of the pair of the base materials.

As described above, according to the present invention, it is possible to provide the manufacturing method of the image display apparatus and the bonding method of the base materials, in which the stress according to heating and cooling of the base material is reduced and the crack does not occur easily in the bonding portion.

Hereinafter, the embodiment of the present invention will be described. The present invention is preferably applicable in an image display apparatus manufacturing method in which a vacuum container is used. In particular, the present invention is preferably applicable to an image display apparatus in which a fluorescent film and an electron accelerating electrode are formed on a face plate of a vacuum envelope and numerous electron-emitting devices are formed on a rear plate thereof. However, it should be noted that the present invention is widely applicable to a case of manufacturing an airtight container by properly bonding plural members, and is also applicable widely as a general bonding method of base materials.

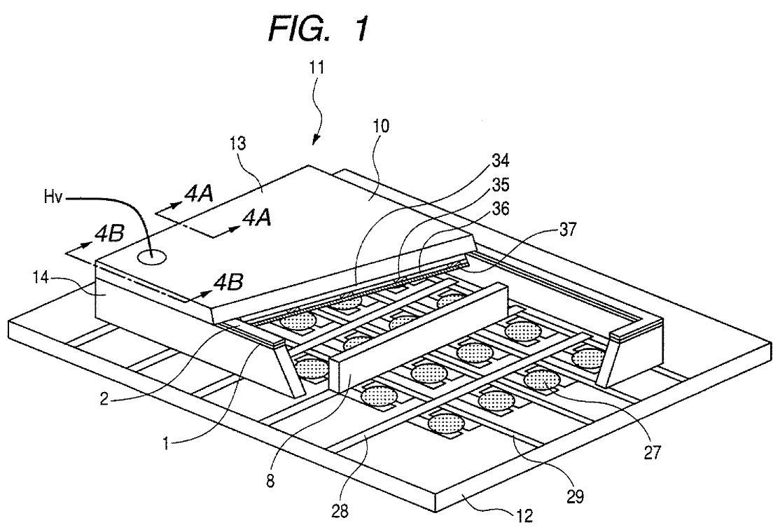

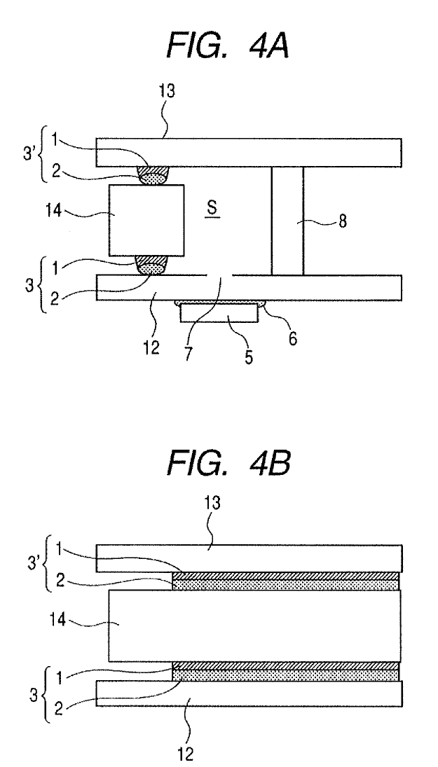

FIG. 1 is a partial cutaway perspective diagram illustrating an example of an image display apparatus to which the present invention is applied. That is, an image display apparatus 11 includes a first substrate (i.e., a rear plate) 12, a second substrate (i.e., a face plate) 13, and a frame member 14. The frame member 14 is positioned between the first substrate 12 and the second substrate 13 to form a closed space S (see FIG. 4A) between the first substrate 12 and the second substrate 13. More specifically, the first substrate 12 and the frame member 14 are bonded to each other through mutually opposite faces thereof, and the second substrate 13 and the frame member 14 are bonded to each other through mutually opposite faces thereof, whereby an envelope 10 having the closed internal space S is formed. Here, the internal space S of the envelope 10 is maintained with vacuum. In the frame member 14, the reverse face of the face fixed to the first substrate 12 is the face fixed to the second substrate 13. The first substrate 12 and the frame member 14 may be previously bonded to each other. In any case, each of the first substrate 12 and the second substrate 13 is made of the glass member, a warp after the bonding still decreases further, whereby it is possible to achieve the bonding in which safety improves and airtightness is excellent.

Further, on the first substrate 12, numerous electron-emitting devices 27 which emit electrons according to image signals are formed, and also wirings (X-direction wirings 28, and Y-direction wirings 29) which cause the respective electron-emitting devices 27 to operate according to the image signals are formed. On the second substrate 13 which is positioned opposite to the first substrate 12, a fluorescent film 34, which emits light in response to irradiation of the electrons emitted by the electron-emitting devices 27 to display an image, is provided. Also, on the second substrate 13, a black stripe is provided. Here, the fluorescent film 34 and the black stripe 35 are alternately arranged. Further, a metal back 36, which is made by an Al thin film, is formed on the fluorescent film 34. The metal back 36, which has a function as an electrode for attracting the electrons, is supplied with potential from a high-voltage terminal Hv provided on the envelope 10. Further, a non-evaporable getter 37, which is made by a Ti thin film, is formed on the metal back 36.

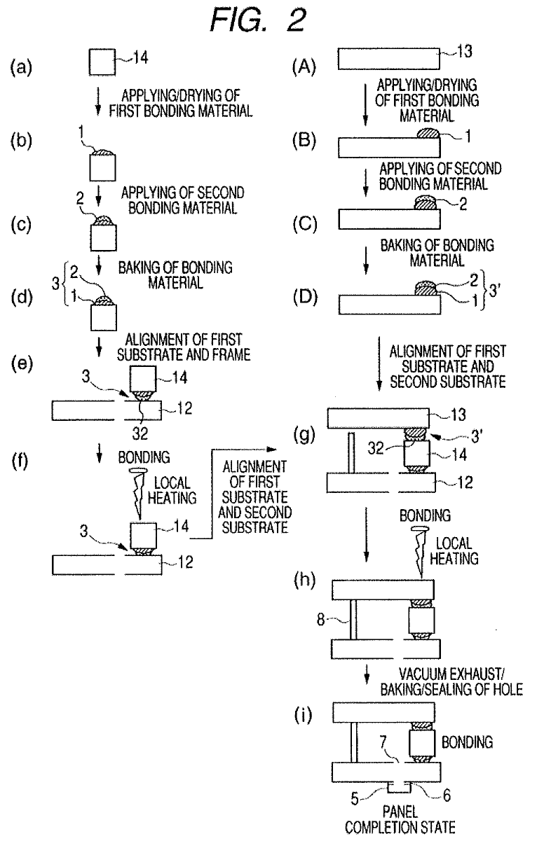

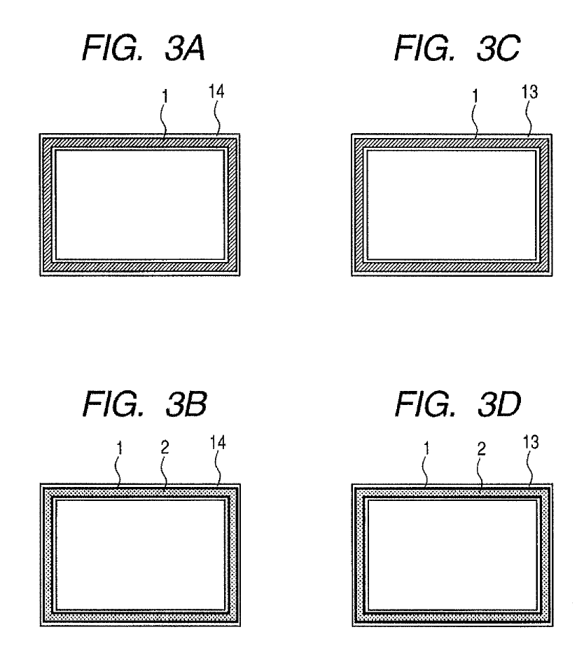

Subsequently, the present embodiment will be described concretely with reference to FIGS. 2, 3A, 3B, 3C, 3D, 4A and 4B. More specifically, FIG. 2 is the cross section diagram for describing a process flow (bonding procedure) according to the present invention. FIGS. 3A, 3B, 3C and 3D are the two-dimensional diagrams each illustrating the bonding portion according to the present invention. More specifically, FIG. 3A corresponds to (b) in FIG. 2, FIG. 3B corresponds to (d) in FIG. 2, FIG. 3C corresponds to (B) in FIG. 2, and FIG. 3D corresponds to (D) in FIG. 2. Further, FIGS. 4A and 4B are the partial cross section diagrams illustrating an example of the bonding portion according to the present invention. More specifically, FIG. 4A is the section diagram obtained along the 4A-4A line in FIG. 1, and FIG. 4B is the section diagram obtained along the 4B-4B line in FIG. 1. Although FIGS. 4A and 4B correspond to a state indicated by (g) in FIG. 2, a bonding material 3 is illustrated in these drawings as a state prior to heating for convenience of description.

(Step S1: Step of Arranging Bonding Material to Frame Member)

Initially, the bonding material 3 which is made by a laminated body consisting of a first bonding material 1 and a second bonding material 2 is arranged on the face of one side of the frame member 14. More specifically, the first bonding material 1 is first formed in screen printing so as to have desired width and thickness along the peripheral length, and then the formed material is dried at 120° C. ((a) in FIG. 2, (b) in FIG. 2, FIG. 3A). After then, the second bonding material 2 which is made of glass frit is formed, as well as the first bonding material 1, in screen printing so as to have a desired thickness on the first bonding material 1 ((c) in FIG. 2). Further, to burn out organic matters, the bonding material is heated and baked at least once at 350° C. or more, whereby the bonding material 3 is formed ((d) in FIG. 2, FIG. 3B). Here, as a method of applying the bonding material, a dispenser method, an offset printing method and the like can be used in addition to such a screen printing method as described above. Since the bonding material is baked at least once at the temperature of 350° C. or more, it is possible to suppress that air bubbles are generated in the bonding material when the bonding is performed, whereby it is possible to achieve the bonding in which airtightness is more excellent.

(Step S1′: Step of Arranging Bonding Material to Second Substrate)

In the same manner as that in the step S1, a bonding material 3′ which is made by a laminated body consisting of the first bonding material 1 and the second bonding material 2 is arranged. More specifically, on the face of the second substrate 13 opposite to the frame member 14, the first bonding material 1 is first formed in screen printing so as to have desired width and thickness along the peripheral length, and then the formed material is dried at 120° C. ((A) in FIG. 2, (B) in FIG. 2, FIG. 3C). After then, the second bonding material 2 is likewise formed in screen printing so as to have a desired thickness on the first bonding material 1 ((C) in FIG. 2). Further, to burn out organic matters, the bonding material is heated and baked at 350° C. or more, whereby the bonding material 3′ is formed ((D) in FIG. 2, FIG. 3D).

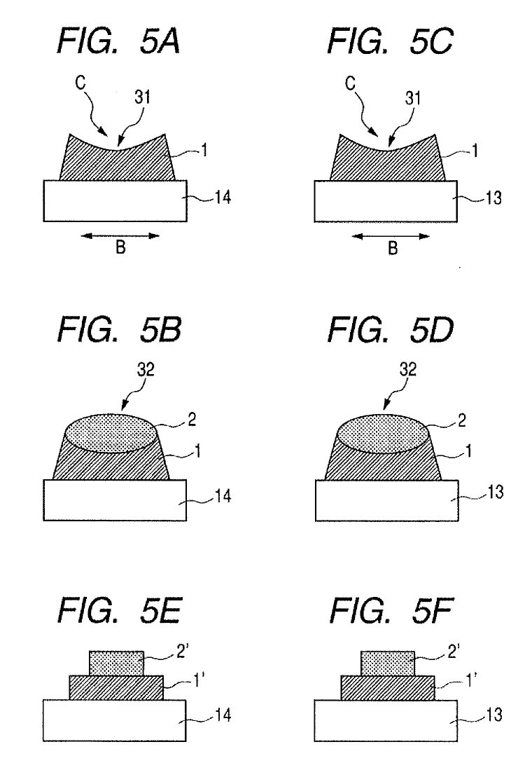

Here, FIGS. 5A, 5B, 5C, 5D, 5E and 5F will be described. To form the bonding material 3 between the first substrate 12 and the frame member 14, as illustrated in FIG. 5A, the first bonding material 1 is first formed on the frame member 14 so as to have a concave portion 31 in which a central region C thereof in a width direction B is concave (i.e., recessed). Then, as illustrated in FIG. 5B, the second bonding material 2 is formed on the concave portion 31 so that a convex portion 32 is formed along the concave portion 31. Likewise, to form the bonding material 3′ between the second substrate 13 and the frame member 14, as illustrated in FIG. 5C, the first bonding material 1 is first formed on the second substrate 13 so as to have the concave portion 31 in which the central region C thereof in the width direction B is concave. Then, the second bonding material 2 is formed on the concave portion 31 so that the convex portion 32 is formed along the concave portion 31. The concave portion 31 like this is obtained by applying the first bonding material 1 made of glass frit in the proper way and then baking the applied glass frit at least once at 120° C. or more. Further, since the first bonding material 1 has been hardened at the time when the second bonding material 2 is applied, the second bonding material 2 is naturally held in the concave portion 31, whereby the convex portion 32 is formed. Here, it is desired for the second bonding material to have a diameter of 0.7 mm to 5 mm. Of course, as illustrated in FIGS. 5E and 5F, a flat first bonding material 1′ and a flat second bonding material 2′ may be formed so that the bonding material 3 or 3′ has a step-like section of which the central region is convex.

(Step S2: Step of Bonding First Substrate and Frame)

Subsequently, the bonding material 3 is put on the first substrate 12 so that the convex portion 32 comes into contact with the first substrate 12, and the frame member 14 is located at a predetermined position on the first substrate 12 ((e) in FIG. 2). Then, light emitted from a halogen lamp or a laser beam output device is condensed and irradiated to the bonding material 3 while the first substrate 12 is being pressed from the side of the frame member 14, whereby the bonding material 3 is locally heated. Thus, the bonding material 3 is melted, and then hardened, whereby the first substrate 12 and the frame member 14 are bonded to each other ((f) in FIG. 2). Here, the light is scanned along the frame bonding material 3, and the first substrate 12 and the frame member 14 are sequentially bonded according to the scanning. The light to be used is not specifically limited, if it is an electromagnetic wave having sufficient energy for enabling to melt the bonding material 3. It is desirable for the light to have a beam diameter which is substantially smaller than the width of the second bonding material 2, i.e., about 0.05 mm to 5 mm, although it depends on the width of the bonding material 3.

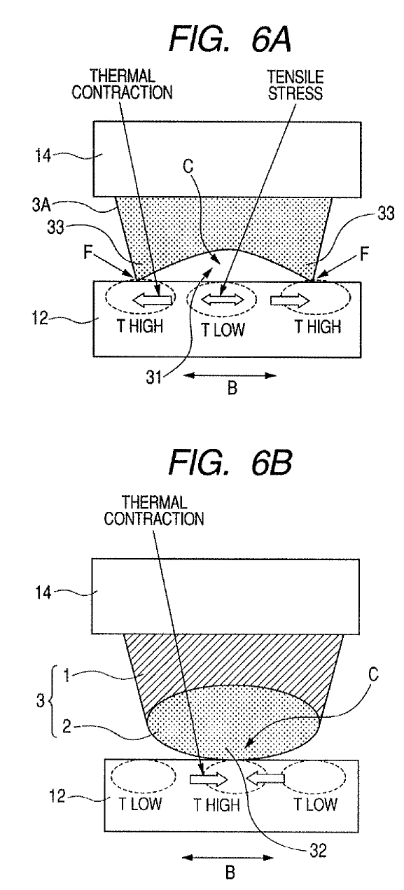

FIGS. 6A and 6B are schematic diagrams for describing an effect of the bonding method according to the present embodiment. More specifically, FIG. 6A illustrates, for comparison, a state at the time when the concave portion is formed at the center of the bonding material in the width direction. In the case where the concave portion 31 is formed in the central region C in the width direction B of a bonding material 3A, the bonding material 3A is in contact with the first substrate 12 at protruding portions 33 at the outer sides of the bonding material 3A in the width direction B. Since the light is condensed to the bonding material 3A, the bonding material 3A is intensively heated. However, the heat is also transmitted from the bonding material 3A to the first substrate 12 mainly through the protruding portions 33 at the both outer sides. Consequently, in a temperature distribution of the first substrate 12, a low temperature portion at the central region is interposed between high temperature portions of the both outer sides in the width direction B of the bonding material 3A. Since the bonding material 3A is flowable when it is heated, the bonding material 3A is easily deformed according to thermal deformation of the first substrate 12, whereby the first substrate 12 is not held by the bonding material 3A. However, when the irradiation of the light ends, the temperature of the bonding material 3A begins to decrease, whereby the bonding material 3A begins to harden. Since the bonding material 3A is deformed when it is melted, the shape of the concave portion 31 is not maintained as it is. However, there is a possibility that the concave portion partially remains. The first substrate 12 itself begins to thermally contract in a state that the first substrate 12 is being held by the bonding material 3A at a holding point F fixed by the hardening of the bonding material 3A. A degree of the thermal contraction is large at both the outer sides where the temperature rise is large, but is small at the central region where the temperature rise is small. As a result, since the central region of the first substrate 12 is pulled from the both sides, a tensile stress is thus applied to the first substrate 12, and this causes crack.

Also, as illustrated in FIG. 6B, in the case where the central region C of the bonding material 3 has the convex portion 32 which protrudes toward the first substrate 12, the first substrate 12 begins to thermally contract after the same process as described above. However, in this case, since the holding (fixed) point F is in the central region C, the first substrate 12 is not held by the hardened bonding material 3. That is, since the whole of the first substrate 12 only contracts as centering on the central region C, an internal stress does not occur easily. Thus, it is possible to prevent that crack occurs.

(Step S3: Step of Bonding Frame Member to which First Substrate has been Bonded to Second Substrate)

Subsequently, a spacer 8 is arranged on the wirings 28 and 29 of the first substrate 12. Then, the second substrate 13 is aligned with the first substrate 12 and arranged on the face of the frame member 14 different from the face thereof bonded to the first substrate 12, so that the convex portion 32 of the bonding material 3′ comes into contact with the frame member 14 ((g) in FIG. 2). Subsequently, light emitted from the halogen lamp or the laser beam output device is condensed and irradiated to the bonding material 3′ while the bonding material 3′ is being pressed from the side of the second substrate 13, whereby the bonding material 3′ is locally heated. Here, such pressing may be performed by mechanically adding a load or adding the atmospheric pressure as decreasing pressure. Thus, the bonding material 3′ is melted, and then hardened, whereby the second substrate 13 and the frame member 14 are bonded to each other ((h) in FIG. 2). At that time, the spacer 8 and the second substrate 13 are in contact with each other, whereby an interval between the first substrate 12 and the second substrate 13 is maintained constantly.

(Step S4: Step of Performing Baking and Sealing)

To increase a degree of vacuum of the internal space of the envelope 10, baking is performed at a predetermined temperature after the heating process. More specifically, the envelope 10 is set up in a vacuum chamber (not illustrated). Subsequently, the degree of vacuum in the chamber is decreased to 10⁻³ Pa or so, as the inside of the envelope 10 is vacuum-exhausted through an exhaust hole 7. After then, the envelope 10 is wholly heated, and the non-evaporable getter 37 is activated. Further, the exhaust hole 7 is sealed by a sealing material 6 and a sealing cover 5, and the image display apparatus 11 is thus formed. As a material of the sealing cover 5, it is desirable to use the material same as that of the first substrate 12. However, it is also possible to use metal or alloy such as Al, Ti, Ni or the like which is not melted in vacuum baking. Further, it is possible to have the same effect as described above even if the heating process ((h) in FIG. 2) is performed after the baking process ((i) in FIG. 2).

To determine the bonding material and the bonding method which are applicable to the image display apparatus, it is necessary to consider the following matters:

(1) heat resistance in the in-vacuum baking (high vacuum forming) process;
(2) maintenance of high vacuum (vacuum leakage minimum, gas permeableness minimum);
(3) securement of adhesiveness to the glass member;
(4) securement of a low outgassing (high vacuum maintaining) characteristic; and
(5) less warp of the image display apparatus after the bonding.

The bonding method according to the present embodiment satisfies all of such conditions.

The above-described embodiment can be generalized as below. That is, a pair of arbitrary base materials to be mutually bonded to each other, such as the pair of the first substrate and the frame member or the pair of the second substrate and the frame member, is supposed. Here, the flat plate and the frame member are supposed as the pair of the base materials. The process of bonding the flat plate and the frame member to each other includes the following steps.

(1) the step of arranging, between the pair of the base materials including the flat plate and the frame member, the bonding material which extends along the frame member.

(2) the step of bonding, as mutually pressing to each other the base materials of the pair of the base materials, the pair of the base materials by the bonding material, by irradiating the electromagnetic wave such as a laser beam or the like to the bonding material while moving the irradiation position along the bonding material to melt the bonding material, and then hardening the melted bonding material.

The process of arranging the bonding material includes the following steps.

(1) the step of arranging the first bonding material on one of the faces (e.g., the frame member) of the pair of the base materials. In this step, the first bonding material is applied like the frame along the frame member, and the applied bonding material is formed so as to have the concave portion which continuously extends in the direction along which the bonding material extends and in which its central region in the width direction is concave to the other of the faces (e.g., the flat plate) of the pair of the base materials.

(2) the step of providing the next (second) bonding material on the concave portion so that the convex portion is formed along the concave portion of the first bonding material. For example, the glass frit is applied in the concave portion of the baked first bonding material so that the convex portion is formed, and then the glass frit formed in the concave portion is baked at least once at 350° C. or more.

Thus, it is possible to arrange the bonding material, on one of the faces of the pair of the base materials mutually opposite to each other, to have the convex portion which continuously extends in the direction along which the bonding material extends and in which its central region in the width direction protrudes toward the other of the faces of the pair of the base materials.

Hereinafter, the present invention will be described in detail by taking concrete examples.

### Example 1

The image display apparatus 11 to which the bonding material and the bonding method of this example are applied has the same constitution as that of the apparatus schematically illustrated in FIG. 1. That is, the plural electron-emitting devices 27 are arranged, as well as the wirings, on the first substrate 12. Further, the first substrate 12 and the frame member 14 are bonded to each other by the first and second bonding materials 1 and 2, and also the second substrate 13 and the frame member 14 are bonded to each other by the first and second bonding materials 1 and 2. The materials of the first substrate 12, the second substrate 13 and the frame member 14 were made the same (i.e., PD200 (available from ASAHI GLASS CO., LTD.)).

In the image display apparatus of this example, the plural (240 rows×720 columns) surface conduction electron-emitting devices 27 are formed on the first substrate 12. The surface conduction electron-emitting devices 27 are electrically connected to the X-direction wirings (also called upper wirings) 28 and the Y-direction wirings (also called lower wirings) 29, whereby the simple matrix wirings are provided. The fluorescent film 34 consisting of striped red, green and blue phosphors (not illustrated) and the black stripe 35 are alternately arranged on the second substrate 13. Further, on the fluorescent film 34, the metal back 36 made by an Al thin film is formed by a sputtering method at the thickness 0.1 μm, and a Ti film formed at the thickness 0.1 μm by an electron beam vacuum vapor deposition method is provided as the non-evaporable getter 37.

Hereinafter, the bonding method of the image display apparatus in this example will be described with reference to FIGS. 1, 2 and 3A to 3D. In this example, the glass frit is used as the bonding material 3.

(Step a) A paste (the first bonding material 1) obtained by compounding terpineol, Elvacite™, and Bi-based lead-free glass frit of BAS115 base (available from ASAHI GLASS CO., LTD.: the thermal expansion coefficient α=75×10⁷/° C.)) acting as the basic material of the first bonding material 1 was prepared. The paste was formed in the screen printing so as to have the width 1 mm and the thickness 10 μm along the peripheral length of the frame member 14, and then dried at 120° C. ((b) in FIG. 2, FIG. 3A). Thus, the concave portion having the central region being continuously concave was formed in the paste.

(Step b) The paste (the second bonding material 2) same as that used in Step a was prepared. The prepared paste was formed, as well as the first bonding material 1, in the screen printing at the width 1 mm and the thickness 10 μm on the dried first bonding material 1 so as to cover the formed concave portion ((c) in FIG. 2). Thus, the convex portion having the central region being continuously convex was formed in the paste.

(Step c) To burn out the organic matters, the bonding material was heated and baked at 480° C., whereby the bonding material 3 was formed ((d) in FIG. 2, FIG. 3B).

(Step A) A paste (the second bonding material 2) obtained by compounding terpineol, Elvacite™, and Bi-based lead-free glass frit of BAS115 base (available from ASAHI GLASS CO., LTD.: the thermal expansion coefficient α=75×10⁻⁷/° C.)) acting as the basic material of the second bonding material 2 was prepared. The paste was formed in the screen printing so as to have the width 1 mm and the thickness 10 μm along the peripheral length on the face of the second substrate 13 opposite to the frame member 14, and then dried at 120° C. ((B) in FIG. 2, FIG. 3C). Thus, the concave portion having the central region being continuously concave was formed in the paste.

(Step B) The paste same as that used in Step A was prepared. The prepared paste was formed, as well as the first bonding material 1, in the screen printing at the width 1 mm and the thickness 10 μm on the dried second bonding material 2 ((C) in FIG. 2). Thus, the convex portion having the central region being continuously convex was formed in the paste.

(Step C) To burn out the organic matters, the bonding material was heated and baked at 480° C., whereby the bonding material 3′ was formed ((D) in FIG. 2, FIG. 3D).

(Step d) The frame member 14 was located at the predetermined position on the first substrate 12 so that the formed convex portion of the bonding material 3 was in contact with the first substrate 12 ((e) in FIG. 2).

(Step e) A semiconductor laser beam having the wavelength 980 nm, the power 130W and the effective diameter 1 mm was irradiated, as scanning at the speed 300 mm/S, to the bonding material 3 while pressing the bonding material from the side of the frame member 14, whereby the bonding material 3 was locally heated. Thus, the bonding material was melted, and then hardened, whereby the first substrate 12 and the frame member 14 were bonded to each other ((f) in FIG. 2).

(Step f) The spacer 8 was arranged on the wirings 28 and 29 of the first substrate 12.

(Step g) The second substrate 13 was arranged on the other face of the frame member 14 to which the first substrate 12 was not bonded, through alignment with the first substrate 12, so that the formed convex portion of the bonding material 3′ was in contact with the frame member 14 ((g) in FIG. 2).

(Step h) A semiconductor laser beam having the wavelength 980 nm, the power 130W and the effective diameter 1 mm was irradiated, as scanning at the speed 300 mm/S, to the bonding material 3′ while pressing the bonding material from the side of the second substrate 13, whereby the bonding material 3′ was locally heated. Thus, the bonding material 3′ was melted, and then hardened, whereby the frame member 14 bonded to the second substrate 13 was bonded to the first substrate 12 ((h) in FIG. 2). The spacer 8 and the second substrate 13 were in contact with each other, whereby the interval between the first substrate 12 and the second substrate 13 was maintained constantly, and the envelope 10 was formed.

(Step i) The envelope 10 was set up in the vacuum chamber (not illustrated). Subsequently, the degree of vacuum in the chamber was set to 10⁻³ Pa or so, as the inside of the envelope 10 was vacuum-exhausted through the exhaust hole 7. Further, the envelope 10 was wholly heated up to 350° C., and the non-evaporable getter 37 was activated. After then, the exhaust hole 7 was sealed by the sealing material 6 made by In and the sealing cover 5 made by a glass substrate, whereby the image display apparatus 11 was formed.

In the image display apparatus of this example shown in FIG. 1 which has been bonded as described above, the convex portion in which the central region is continuously convex is formed in the paste in the steps a and b (the steps A and B). Thus, occurrence of crack in the bonding portion due to the thermal contraction is suppressed, thereby achieving the laser bonding in which safety improves and airtightness is excellent.

### Example 2

This example is the same as the example 1 except that, as a material of the frame member, soda lime glass (AS soda lime glass: the thermal expansion coefficient 87×10⁻⁷/° C.) is used instead of PD200. Also, in this example, the convex portion in which the central region is continuously convex is formed in the paste. Thus, occurrence of crack in the bonding portion due to the thermal contraction is suppressed, thereby achieving the laser bonding in which safety improves and airtightness is excellent. In this example, the non-evaporable getter 37 was set on the second substrate 13. However, the non-evaporable getter 37 may be set on the wiring of the first substrate 12 (not illustrated).

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-211715, filed Sep. 14, 2009, which is hereby incorporated by reference herein in its entirety.

What is claimed is:

1. A manufacturing method of an image display apparatus which comprises a first substrate having numerous electron-emitting devices, a second substrate positioned opposite to the first substrate and having a fluorescent film of displaying an image in response to irradiation of electrons emitted from the electron-emitting devices, and a frame member positioned between the first substrate and the second substrate to form a space between the first substrate and the second substrate, the method comprising:
arranging a bonding material between a pair of base materials acting as the first substrate and the frame member or acting as the second substrate and the frame member, the bonding material extending along one of the base materials acting as the frame member; and
bonding, as mutually pressing to each other the base materials of the pair of the base materials, the pair of the base materials by the bonding material, by irradiating an electromagnetic wave to the bonding material while moving an irradiation position along the bonding material to melt the bonding material, and then hardening the melted bonding material,
wherein the arranging of the bonding material includes arranging the bonding material on one of faces of the pair of the base materials mutually opposite to each other so as to have a convex portion which continuously extends in a direction along which the bonding material extends and in which its central region in a width direction protrudes toward the other of the faces of the pair of the base materials.

2. The manufacturing method according to claim 1, wherein the arranging of the bonding material includes
providing a first bonding material on the one of the faces of the pair of the base materials so as to have a concave portion which continuously extends in the direction along which the bonding material extends and in which its central region in the width direction is concave to the other of the faces of the pair of the base materials, and
providing a second bonding material on the concave portion so that the convex portion is formed along the concave portion of the first bonding material.

3. The manufacturing method according to claim 2, wherein
the providing of the first bonding material includes applying glass frit on the one of the faces of the pair of the base materials so that the concave portion is formed, and then baking the glass frit at least once at a temperature of 350° C. or more, and
the providing of the second bonding material includes applying glass frit to the concave portion of the baked first bonding material so that the convex portion is formed, and then baking the glass frit in the concave portion at least once at a temperature of 350° C. or more.

4. The manufacturing method according to claim 1, wherein the pair of the base material includes glass.

5. A bonding method of base materials, comprising:
arranging a bonding material between a pair of the base materials including a flat plate and a frame member, the bonding material extending along the frame member; and
bonding, as mutually pressing to each other the base materials of the pair of the base materials, the pair of the base materials by the bonding material, by irradiating an electromagnetic wave to the bonding material while moving an irradiation position along the bonding material to melt the bonding material, and then hardening the melted bonding material,
wherein the arranging of the bonding material includes arranging the bonding material on one of faces of the pair of the base materials mutually opposite to each other so as to have a convex portion which continuously extends in a direction along which the bonding material extends and in which its central region in a width direction protrudes toward the other of the faces of the pair of the base materials.
